(19) United States
(12) Patent Application Publication
(10) Pub. No.: US 2024/0412064 A1
(43) Pub. Date: Dec. 12, 2024

(54) CALCULATION DEVICE, CALCULATION METHOD, AND CALCULATION PROGRAM

(71) Applicant: NIPPON TELEGRAPH AND TELEPHONE CORPORATION, Tokyo (JP)

(72) Inventors: Toshiki SHIBAHARA, Musashino-shi, Tokyo (JP); Takayuki MIURA, Musashino-shi, Tokyo (JP); Masanobu KII, Musashino-shi, Tokyo (JP); Atsunori ICHIKAWA, Musashino-shi, Tokyo (JP)

(73) Assignee: NIPPON TELEGRAPH AND TELEPHONE CORPORATION, Tokyo (JP)

(21) Appl. No.: 18/701,935

(22) PCT Filed: Oct. 18, 2021
(86) PCT No.: PCT/JP2021/038500

§ 371 Date: Apr. 17, 2024

(51) Int. Cl. G06N 3/08

(52) U.S. Cl. CPC G06N 3/08

(57) ABSTRACT

A calculation device includes processing circuitry configured to create a second data set adjacent to a first data set based on the first data set, perform learning of a Bayesian neural network (NN) by using either the first data set or the second data set as training data, determine whether the training data used for the learning of the Bayesian NN is the first data set or the second data set based on an output of the Bayesian NN learned, and calculate a privacy risk based on a determination result.

### TECHNICAL FIELD

The present invention relates to a calculation device, a calculation method, and a calculation program.

### BACKGROUND ART

It has been pointed out that there is a privacy risk in a machine learning technology represented by a deep neural network (DNN). This is because a learned model has a characteristic of easily storing training data.

Specifically, it is shown that whether specific data is included in training data can be estimated from the output of the learned model. In particular, in a case of handling data that the user does not want other people to know, such as medical data and a web browsing history, it is necessary to consider a privacy risk.

On the other hand, a method for calculating a privacy risk on the basis of how successful an attack for identifying whether certain data is included in a data set is known (see, for example, Non Patent Literature 1 and Non Patent Literature 2).

### CITATION LIST

### Non Patent Literature

Non Patent Literature 1: Jagielski, M. et al.: Auditing differentially private machine learning: How private is private sgd?, arXiv preprint arXiv: 2006.07709 (2020).
Non Patent Literature 2: Nasr, M. et al.: Adversary instantiation: Lower bounds for differentially private machine learning, arXiv preprint arXiv: 2101.04535 (2021).

### SUMMARY OF INVENTION

### Technical Problem

However, the related technology has a problem that it is difficult to calculate the privacy risk of the Bayesian NN.

The methods disclosed in Non Patent Literature 1 and Non Patent Literature 2 target a model using a deterministic NN that outputs one predicted value with respect to an input.

On the other hand, since the Bayesian NN outputs posterior distribution of predicted values or a value sampled from posterior distribution, the related method cannot be applied.

### Solution to Problem

In order to solve the above-described problems and achieve the object, a calculation device includes: a creation unit that creates a second data set adjacent to a first data set based on the first data set; a learning unit that performs learning of a Bayesian neural network (NN) by using either the first data set or the second data set as training data; a determination unit that determines whether the training data used for the learning of the Bayesian NN is the first data set or the second data set based on an output of the Bayesian NN learned by the learning unit; and a calculation unit that calculates a privacy risk based on a determination result by the determination unit.

### Advantageous Effects of Invention

According to the present invention, it is possible to calculate a privacy risk of a Bayesian NN.

### BRIEF DESCRIPTION OF DRAWINGS

FIG. 1 is a diagram for explaining a calculation method of a privacy risk.

FIG. 2 is a diagram illustrating a configuration example of a calculation device according to a first embodiment.

FIG. 3 is a diagram for explaining a data set determination method.

FIG. 4 is a flowchart illustrating a flow of processing of the calculation device according to the first embodiment.

FIG. 5 is a diagram illustrating an example of a computer that executes a calculation program.

### DESCRIPTION OF EMBODIMENTS

Hereinafter, embodiments of a calculation device, a calculation method, and a calculation program according to the present application will be described in detail with reference to the drawings. Note that the present invention is not limited to the embodiments described below.

In a first embodiment, a privacy risk particularly related to a Bayesian neural network (NN) is calculated.

The Bayesian NN is a machine learning technology based on the NN. Parameters such as weights and biases in the Bayesian NN are treated as following probability distribution. Posterior distribution of each parameter is obtained by Bayesian estimation.

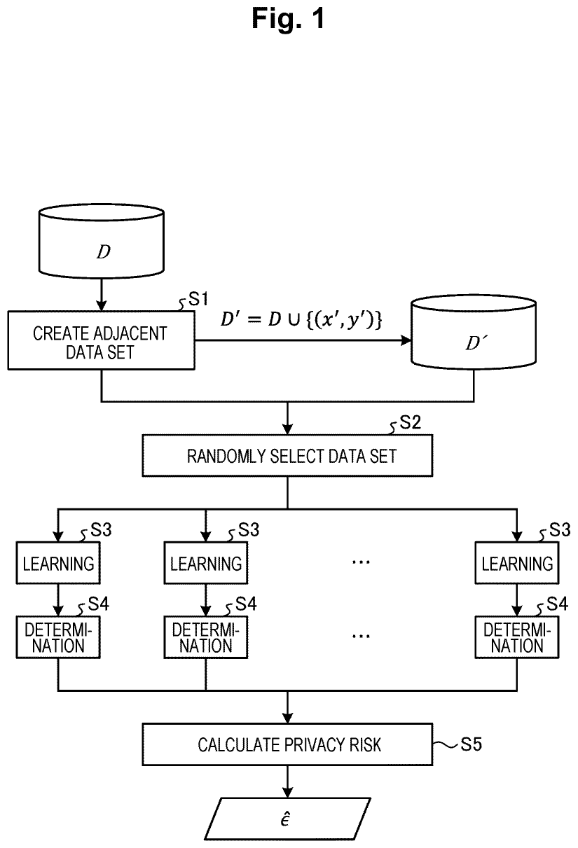

A privacy risk calculation method by a calculation device according to the first embodiment will be described with reference to FIG. 1. FIG. 1 is a diagram for explaining a calculation method of a privacy risk.

As illustrated in FIG. 1, first, the calculation device creates an adjacent data set D′ from a data set D (step S1).

For example, when the data set D includes a plurality of pieces of data each of which can be represented in a format such as (x, y) as an element, the calculation device creates a data set D′ by adding data (x′, y′) to the data set D.

Then, the calculation device randomly selects one of the data set D and the data set D′ (step S2).

Next, the calculation device learns a model by using the selected data set as training data (step S3). For example, the model is a Bayesian NN.

Here, the calculation device determines whether the data set used as the training data is the data set D or the data set D′ on the basis of the output of the learned model (step S4).

The calculation device calculates the privacy risk on the basis of the determination result (step S5). For example, it can be said that as the determination accuracy in step S4 is higher, an attack is more likely to succeed, and the privacy risk is higher.

For example, high determination accuracy means that it is easy to estimate the data set that has been used for learning from an output, and means that it is easy to specify that data of (x′, y′) has been used for learning.

The calculation device selects the data set a plurality of times in step S2, and performs learning in step S3 and determination in step S4 each time the data set is selected.

At that time, even if the selected data sets are the same, the learned Bayesian NNs are not necessarily the same.

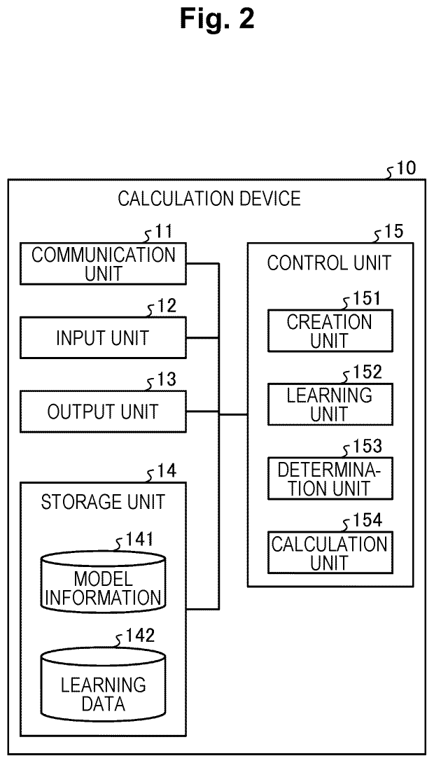

Hereinafter, details of each processing described with reference to FIG. 1 will be described together with the configuration of the calculation device according to the embodiment.

[Configuration of First Embodiment] The configuration of the calculation device according to the first embodiment will be described with reference to FIG. 2. FIG. 2 is a diagram illustrating a configuration example of the calculation device according to the first embodiment. A calculation device 10 receives an input of a data set and calculates a privacy risk regarding a Bayesian NN.

As illustrated in FIG. 2, the calculation device 10 includes a communication unit 11, an input unit 12, an output unit 13, a storage unit 14, and a control unit 15.

The communication unit 11 performs data communication with other devices via a network. For example, the communication unit 11 is a network interface card (NIC).

The input unit 12 accepts an input of data from a user. The input unit 12 is, for example, an input device such as a mouse or a keyboard, or an interface connected to the input device.

The output unit 13 outputs data by displaying a screen or the like. The output unit 13 is, for example, an output device such as a display and a speaker, or an interface connected to the output device.

The storage unit 14 is a storage device such as a hard disk drive (HDD), a solid state drive (SSD), or an optical disc. Note that the storage unit 14 may be a semiconductor memory capable of rewriting data, such as a random access memory (RAM), a flash memory, or a non-volatile static random access memory (NVSRAM).

The storage unit 14 stores an operating system (OS) and various programs executed by the calculation device 10. The storage unit 14 stores model information 141 and learning data 142.

The model information 141 is, for example, a hyperparameter (number of layers, number of units, activation function, and the like) of a model using a Bayesian NN. More specifically, the model information 141 may be parameters such as an average and a variance for specifying a probability distribution followed by a weight and a bias.

The learning data 142 is data for performing learning of the Bayesian NN. For example, the learning data 142 is the data set D.

For example, the data set D may have data obtained by combining a label and a feature amount as an element.

The control unit 15 controls the entire calculation device 10. The control unit 15 is, for example, an electronic circuit such as a central processing unit (CPU), a micro processing unit (MPU), or a graphics processing unit (GPU), or an integrated circuit such as an application specific integrated circuit (ASIC) or a field programmable gate array (FPGA).

Further, the control unit 15 includes an internal memory for storing programs and control data defining various processing procedures, and executes each type of processing using the internal memory.

The control unit 15 functions as various processing units by various programs operating. For example, the control unit 15 includes a creation unit 151, a learning unit 152, a determination unit 153, and a calculation unit 154.

The creation unit 151 creates a data set D′ adjacent to the data set D on the basis of the data set D. The data set D is an example of a first data set. The data set D′ is an example of a second data set.

As described with reference to FIG. 1, the creation unit 151 creates the data set D′ by adding data (x′, y′) to the data set D.

In this case, the data set D and the data set D′ can be said as two data sets having only one element different from each other.

For example, the data (x′, y′) is selected from pieces of data included in the data set D. The data (x′, y′) may be randomly selected.

For example, the data (x′, y′) may be such data that the influence increases when the data set D′ is used as training data. The magnitude of the influence increases as the loss of the model when learning is performed using the data set D′ as training data increases.

The data (x′, y′) may be selected according to the kind of privacy risk that is desired to be calculated. The creation unit 151 may create the data set D′ by adding noise to the data (x′, y′) and then adding the data to the data set D.

The learning unit 152 learns a Bayesian neural network (NN) by using one of the data set D and the data set D′ as training data.

For example, the learning unit 152 randomly selects one of the data set D and the data set D′, and learns the model by using the selected data set as training data.

For example, the model is a Bayesian NN in an unlearned state constructed from the model information 141. The learning unit 152 can construct a model from the model information 141 and perform learning each time a data set is selected.

The learning unit 152 can perform learning by a known machine learning method. The learning unit 152 may perform learning by a method of privacy protection machine learning (for example, a learning method in which differential privacy is guaranteed).

The determination unit 153 determines whether the training data used for learning of the Bayesian NN is the data set D or the data set D′ on the basis of the output of the Bayesian NN learned by the learning unit 152. For example, the determination unit 153 makes a determination on the basis of an output obtained by inputting one sample to the Bayesian NN once or a plurality of times, or an output obtained by inputting each of the plurality of samples to the Bayesian NN once or a plurality of times.

For example, the determination unit 153 performs determination using an output when data (x′, y′) is input to the learned Bayesian NN. The determination unit 153 may perform determination using an output when noise is added to data (x′, y′) and then the data is input to the learned Bayesian NN.

The determination unit 153 can determine whether the training data used for learning of the Bayesian NN is the data set D or the data set D′ on the basis of information obtained by integrating a plurality of outputs obtained by inputting one sample to the Bayesian NN learned by the learning unit 152 a plurality of times or inputting each of the plurality of samples to the Bayesian NN one or more times. The determination unit 153 may perform determination on the basis of one output obtained by inputting one sample to the Bayesian NN only once.

For example, the determination unit 153 determines whether the training data is the data set D or the data set D′ for each of the outputs obtained by inputting a plurality of samples to the learned Bayesian NN. As a result, the determination unit 153 can obtain a plurality of determination results.

For example, when all the determination results of the plurality of determination results indicate that the training data is the data set D′, the determination unit 153 finally determines that the training data is the data set D′.

For example, when one or more determination results among the plurality of determination results indicate that the training data is the data set D′, the determination unit 153 finally determines that the training data is the data set D′.

For example, when the number of determination results indicating that the training data is the data set D′ among the plurality of determination results is larger than the number of determination results indicating that the training data is the data set D, the determination unit 153 finally determines that the training data is the data set D′.

Here, the output of the Bayesian NN is determined according to predetermined posterior distribution. The Bayesian NN can output a statistical value such as the average of the posterior distribution.

When the Bayesian NN outputs the statistical value of the posterior distribution, the determination unit 153 determines whether the training data used for learning of the Bayesian NN is the data set D or the data set D′ on the basis of the statistical value.

The Bayesian NN may output a plurality of predicted values sampled from the posterior distribution.

When the Bayesian NN outputs a plurality of predicted values sampled from the posterior distribution, the determination unit 153 determines whether the training data used for learning of the Bayesian NN is the data set D or the data set D′ on the basis of the statistical values regarding the plurality of predicted values.

In any case, the number of types of statistical values may be one or plural. The type of the statistical value is, for example, an average, a maximum value, a minimum value, an i-th (where i is an integer from 1 to the number of samples) smallest value among predicted values, or the like.

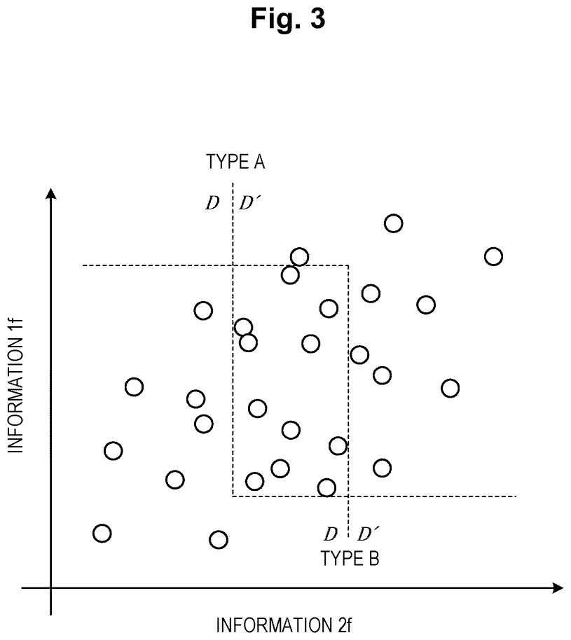

A data set determination method using the statistical value by the determination unit 153 will be described with reference to FIG. 3. FIG. 3 is a diagram for explaining a data set determination method.

Each of information 1f and information 2f corresponds to a predetermined type of statistical value. For example, the information 1f may be an average, and the information 2f may be a maximum value.

The determination unit 153 determines whether the training data used for learning of the Bayesian NN is the data set D or the data set D′ depending on whether the statistical value is equal to or greater than a threshold.

For example, the determination unit 153 determines that the training data is the data set D′ when all types of statistical values are equal to or greater than the threshold. This determination method corresponds to type A in FIG. 3.

As illustrated in FIG. 3, the region determined as the data set D′ in the determination method of type A is an overlapping portion of a region in which the information 1f is equal to or greater than the threshold and a region in which the information 2f is equal to or greater than the threshold.

For example, the determination unit 153 determines that the training data is the data set D′ when any type of statistical values are equal to or greater than the threshold. This determination method corresponds to type B in FIG. 3.

As illustrated in FIG. 3, the region determined as the data set D′ in the determination method of type B is both a region in which the information 1f is equal to or greater than the threshold and a region in which the information 2f is equal to or greater than the threshold.

The regions are not limited to the regions of the type A and the type B and the determination unit 153 can determine that the training data is the data set D′ when a point determined from each piece of information exists in a region designated in advance in a plane as illustrated in FIG. 3 (a space when there are three or more pieces of information).

The information used for the determination based on the threshold is desirably a value that tends to increase when the training data is the data set D′. Statistical values such as an average, a maximum value, and a minimum value have such a tendency.

On the other hand, the standard deviation tends to be small when the training data is the data set D′. Therefore, instead of the standard deviation itself, the determination unit 153 can use a reciprocal of the standard deviation or a value obtained by inverting the sign of the standard deviation as information for determination.

When the Bayesian NN outputs a predetermined statistical value without outputting a plurality of predicted values, the determination unit 153 performs determination using the statistical value.

For example, when the Bayesian NN outputs only the average and the standard deviation, the determination unit 153 cannot perform determination using statistical values other than the average and the standard deviation.

This makes it possible to evaluate how the privacy risk changes depending on how the output of the Bayesian NN is disclosed.

The calculation unit 154 calculates a privacy risk on the basis of the determination result by the determination unit 153.

Here, it is assumed that learning by the learning unit 152 and determination by the determination unit 153 are performed a plurality of times.

When the actual training data is the data set D, a rate at which the determination unit 153 determines that the training data is the data set D′ is set as a false positive rate (FPR).

On the other hand, when the actual training data is the data set D′, a rate at which the determination unit 153 determines that the training data is the data set D is set as a false negative rate (FNR).

At this time, the calculation unit 154 can calculate the privacy risk by Expression (1).

$$\begin{matrix}[ Math . 1 ] & \\ \hat{ϵ} = max ( log \frac{1 - δ - FPR}{FNR} , log \frac{1 - δ - FNR}{FPR} ) & ( 1 )\end{matrix}$$

δ is a sufficiently small constant (for example, 10⁻⁵). The determination unit 153 may use a threshold that increases the privacy risk calculated from Expression (1). The calculation unit 154 may calculate the privacy risk in consideration of a confidence interval.

The calculation unit 154 may calculate the privacy risk by a method based on a probability ratio and a method using a predetermined test method in addition to the method using Expression (1).

### Example

The calculation device 10 can compare the privacy risk between the deterministic NN and the Bayesian NN by, for example, the method described below. This makes it possible to evaluate the degree of increase in privacy risk when the Bayesian NN is introduced.

First, the calculation device 10 uses a convolutional neural network (CNN) to which Dropout is applied as the NN. The calculation device 10 learns a CNN by differentially private (DP)-stochastic gradient descent (SGD).

The calculation device 10 calculates the privacy risk of the Bayesian NN obtained by applying MC dropout to the CNN by the method of the embodiment.

Next, the calculation device 10 calculates a privacy risk as a deterministic NN of the CNN by a related method (for example, the method disclosed in Non Patent Literature 1 or Non Patent Literature 2).

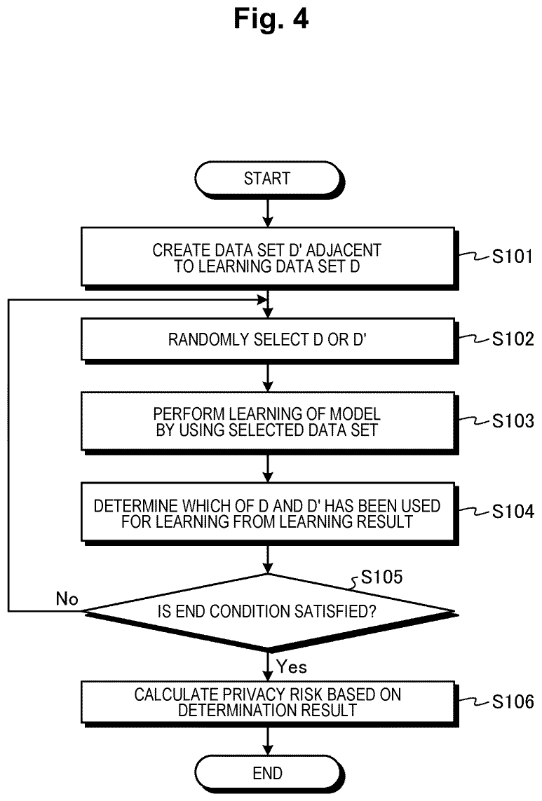

The calculation device 10 compares the privacy risk of the Bayesian NN with the privacy risk of the CNN as a deterministic NN.

[Processing of First Embodiment] A flow of processing of the calculation device 10 will be described with reference to FIG. 4. FIG. 4 is a flowchart illustrating a flow of processing of the calculation device according to the first embodiment.

As illustrated in FIG. 4, first, the calculation device 10 creates a data set D′ adjacent to the learning data set D (step S101). For example, the calculation device 10 creates the data set D′ by adding data (x′, y′) to the data set D.

Next, the calculation device 10 randomly selects one of the data set D or the data set D′ (step S102). The calculation device 10 performs selection a plurality of times.

The calculation device 10 learns the model using the selected data set (step S103). The calculation device 10 may perform learning by a method of privacy protection machine learning.

The calculation device 10 determines which one of the data set D and the data set D′ is used for learning from the learning result (step S104). For example, the calculation device 10 makes a determination using a statistical value related to the output of the model.

Until the end condition is satisfied (step S105, No), the calculation device 10 repeats steps S102 to S104. The end condition is that steps S102 to S104 are repeated a certain number of times, for example.

On the other hand, when the end condition is satisfied (step S105, Yes), the calculation device 10 proceeds to step S106.

The calculation device 10 calculates a privacy risk on the basis of the determination result (step S106). For example, the calculation device 10 can calculate the privacy risk from the FPR and the FNR in a case where it is determined that the training data is the data set D′ as positive.

[Effects of First Embodiment] As described above, the creation unit 151 creates the second data set adjacent to the first data set on the basis of the first data set. The learning unit 152 learns a Bayesian neural network (NN) by using one of the first data set and the second data set as training data. The determination unit 153 determines whether the training data used for learning of the Bayesian NN is the first data set or the second data set on the basis of the output of the Bayesian NN learned by the learning unit 152. The calculation unit 154 calculates a privacy risk on the basis of the determination result by the determination unit 153.

As described above, the calculation device 10 determines the data set of the training data on the basis of the output of the Bayesian NN, and calculates the privacy risk from the determination result. As a result, according to the present embodiment, it is possible to calculate a privacy risk of a Bayesian NN.

The determination unit 153 determines whether the training data used for learning of the Bayesian NN is the first data set or the second data set on the basis of information obtained by integrating a plurality of outputs obtained by inputting one sample to the Bayesian NN learned by the learning unit 152 a plurality of times or inputting each of the plurality of samples to the Bayesian NN one or more times. In this manner, the calculation device 10 can perform statistical determination using, for example, FPR and FNR by using a plurality of outputs.

When the Bayesian NN outputs the statistical value of the posterior distribution, the determination unit 153 determines whether the training data used for learning of the Bayesian NN is the first data set or the second data set on the basis of the statistical value. In this manner, the calculation device 10 can easily perform determination using the output of the Bayesian NN.

When the Bayesian NN outputs a plurality of predicted values sampled from the posterior distribution, the determination unit 153 determines whether the training data used for learning of the Bayesian NN is the first data set or the second data set on the basis of the statistical values regarding the plurality of predicted values. In this manner, the calculation device 10 can perform determination using any statistical value using the output of the Bayesian NN.

The determination unit 153 determines whether the training data used for learning of the Bayesian NN is the first data set or the second data set depending on whether the statistical value is equal to or greater than a threshold. In this manner, the calculation device 10 can easily perform determination using a threshold.

[System Configuration and Others] Moreover, each component of each illustrated device is functionally conceptual, and does not necessarily need to be physically configured as illustrated. That is, a specific form of distribution and integration of each device is not limited to the illustrated form, and all or some thereof can be functionally or physically distributed or integrated in any unit according to various loads, usage conditions, and the like. Furthermore, the whole or any part of each processing function performed in each device can be implemented by a central processing unit (CPU) and a program analyzed and executed by the CPU, or may be implemented as hardware by wired logic. Note that the program may be executed not only by a CPU but also by another processor such as a GPU.

Also, among the respective processes described in this embodiment, all or some of the processes described as being automatically performed can be manually performed, or all or some of the processes described as being manually performed can be automatically performed by a known method. In addition to the above, the processing procedures, the control procedures, the specific names, and the information including various kinds of data and parameters that are illustrated in the above literatures and drawings can be changed as appropriate, unless otherwise specified.

[Program] As an embodiment, the calculation device 10 can be implemented by installing, as packaged software or online software, a calculation program for executing the above calculation processing in a desired computer. For example, by causing an information processing apparatus to execute the above calculation program, the information processing apparatus can be caused to function as the calculation device 10. The information processing apparatus mentioned here includes a desktop or a laptop personal computer. In addition, the information processing apparatus includes a mobile communication terminal such as a smartphone, a mobile phone, or a personal handyphone system (PHS) and a slate terminal such as a personal digital assistant (PDA).

Furthermore, the calculation device 10 can also be implemented as a calculation server device with a terminal device used by a user as a client which provides the client with a service related to the calculation processes stated above. For example, the calculation server device is implemented as a server device that provides a calculation service having a data set as an input and a privacy risk of the Bayesian NN as an output. In this case, the calculation server apparatus may be implemented as a web server or may be implemented as a cloud that provides a service related to the above calculation processing by outsourcing.

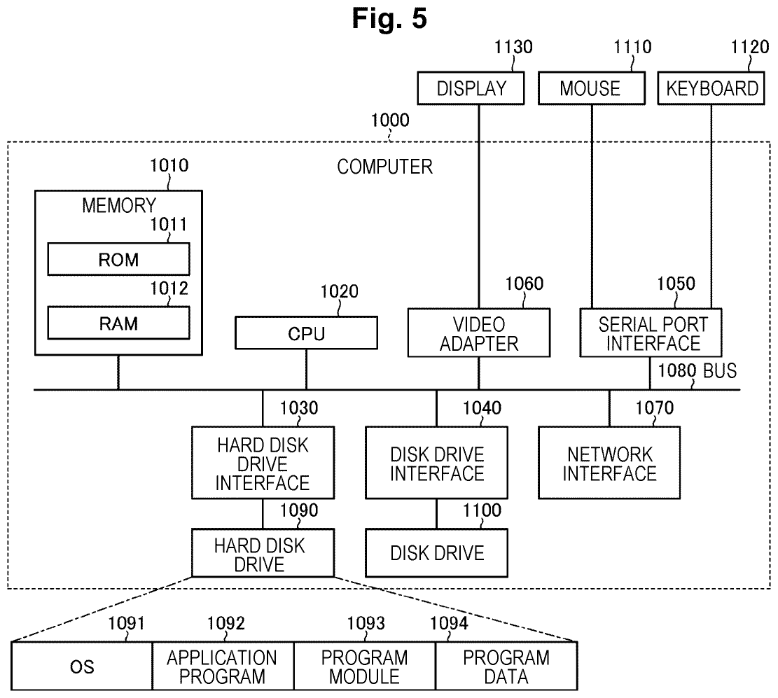

FIG. 5 is a diagram illustrating an example of a computer that executes a calculation program. The computer 1000 includes, for example, a memory 1010 and a CPU 1020. Furthermore, the computer 1000 also includes a hard disk drive interface 1030, a disk drive interface 1040, a serial port interface 1050, a video adapter 1060, and a network interface 1070. These units are connected to each other via a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected with, for example, a display 1130.

The hard disk drive 1090 stores, for example, an OS 1091, an application program 1092, a program module 1093, and program data 1094. That is, the program that defines each processing of the calculation device 10 is implemented as the program module 1093 in which codes executable by the computer are described. The program module 1093 is stored in, for example, the hard disk drive 1090. For example, the program module 1093 for executing processing similar to the functional configurations in the calculation device 10 is stored in the hard disk drive 1090. Note that the hard disk drive 1090 may be replaced with a solid state drive (SSD).

Further, setting data used in the processing of the above embodiment is stored in, for example, the memory 1010 or the hard disk drive 1090 as the program data 1094. Then, the CPU 1020 reads the program module 1093 and the program data 1094 stored in the memory 1010 or the hard disk drive 1090 to the RAM 1012 as necessary and performs the processing of the above embodiment.

Note that the program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (local area network (LAN), wide area network (WAN), or the like). Then, the program module 1093 and the program data 1094 may be read by the CPU 1020 from another computer via the network interface 1070.

### REFERENCE SIGNS LIST

10 Calculation device
11 Communication unit
12 Input unit
13 Output unit
14 Storage unit
15 Control unit
141 Model Information
142 Learning data
151 Creation unit
152 Learning unit
153 Determination unit
154 Calculation unit

1. A calculation device comprising:
processing circuitry configured to:
create a second data set adjacent to a first data set based on the first data set;
perform learning of a Bayesian neural network (NN) by using either the first data set or the second data set as training data;
determine whether the training data used for the learning of the Bayesian NN is the first data set or the second data set based on an output of the Bayesian NN learned; and
calculate a privacy risk based on a determination result.

2. The calculation device according to claim 1, wherein the processing circuitry is further configured to determine whether the training data used for learning of the Bayesian NN is the first data set or the second data set based on information obtained by integrating a plurality of outputs obtained by inputting one sample to the Bayesian NN learned a plurality of times or inputting each of a plurality of samples to the Bayesian NN one or more times.

3. The calculation device according to claim 1, wherein, when the Bayesian NN outputs a statistical value of posterior distribution, the processing circuitry is further configured to determine whether the training data used for learning of the Bayesian NN is the first data set or the second data set based on the statistical value.

4. The calculation device according to claim 1, wherein, when the Bayesian NN outputs a plurality of predicted values sampled from posterior distribution, the processing circuitry is further configured to determine whether the training data used for learning of the Bayesian NN is the first data set or the second data set based on a statistical value regarding the predicted values.

5. The calculation device according to claim 3, wherein the processing circuitry is further configured to determine whether the training data used for learning of the Bayesian NN is the first data set or the second data set depending on whether the statistical value is equal to or greater than a threshold.

6. A calculation method performed by a calculation device, the calculation method comprising:
creating a second data set adjacent to a first data set based on the first data set;
performing learning of a model by using either the first data set or the second data set as training data;
determining whether the training data used for the learning of the model is the first data set or the second data set based on an output of the model learned in the learning step; and
calculating a privacy risk based on a determination result.

7. A non-transitory computer-readable recording medium storing therein a calculation program that causes a computer to execute a process comprising:
creating a second data set adjacent to a first data set based on the first data set;
performing learning of a model by using either the first data set or the second data set as training data;
determining whether the training data used for the learning of the model is the first data set or the second data set based on an output of the model learned; and
calculating a privacy risk based on a determination result.
